(19) United States
(12) Patent Application Publication
(10) Pub. No.: US 2026/0074729 A1
(43) Pub. Date: Mar. 12, 2026

(54) WIRELESS COMMUNICATION APPARATUS AND WIRELESS COMMUNICATION SYSTEM

(71) Applicant: CANON KABUSHIKI KAISHA, Tokyo (JP)

(72) Inventors: TAKAYA NISHIZAWA, Kanagawa (JP); TADASHI EGUCHI, Tokyo (JP)

(21) Appl. No.: 19/313,209

(22) Filed: Aug. 28, 2025

(30) Foreign Application Priority Data
Sep. 9, 2024 (JP) 2024-154915

(51) Int. Cl. H04B 1/38

(52) U.S. Cl. CPC H04B 1/38

(57) ABSTRACT

A wireless communication apparatus configured to perform wireless communication with another wireless communication apparatus includes a coupler configured to be electromagnetically coupled to the another wireless communication apparatus, wherein the coupler includes a signal line and a ground surface including a conductor, and wherein the ground surface does not include the conductor in a part of a region overlapping with the signal line in a plan view.

### BACKGROUND

### Field of the Technology

The present disclosure relates to a wireless communication apparatus and a wireless communication system.

### Description of the Related Art

In recent years, there has been growing interest in wireless communication techniques using electromagnetic field coupling for replacing wiring in movable portions of industrial equipment and similar applications. Eliminating the need for wiring offers potential advantages, such as saving space in communication components and enabling maintenance-free operation by preventing deterioration caused by wearing of wires. Conceivable examples of a communication coupler to be used in such a case include a transmission line coupler as described in Japanese Patent Application Laid-Open No. 08-224232. The transmission line coupler can be applied to a configuration in which two couplers are fixed to face each other, and a configuration in which one of the couplers is made with a longer transmission line than that of the other and the one with the shorter transmission line slides and moves on the other one.

### SUMMARY

The present disclosure is directed to provision of a wireless communication apparatus using a compact coupler that can perform stable communication, and a wireless communication system.

According to an aspect of the present disclosure, a wireless communication apparatus configured to perform wireless communication with another wireless communication apparatus includes a coupler configured to be electromagnetically coupled to the another wireless communication apparatus, wherein the coupler includes a signal line and a ground surface including a conductor, and wherein the ground surface does not include the conductor in a part of a region overlapping with the signal line in a plan view.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an overview configuration of a wireless communication system according to a first exemplary embodiment.

FIG. 2 is a characteristic diagram illustrating a simulation result indicating a gain obtained in a reception coupler with use of a transmission line in which holes are formed in a ground surface.

FIG. 3A is a characteristic diagram illustrating simulation results with a reception coupler and a transmission coupler that obtain the gain illustrated in in FIG. 2 in a case where a signal line in the reception coupler and a signal line in the transmission coupler directly face each other at respective center positions and in a case where they are shifted from each other by 0.5 mm.

FIG. 3B is a characteristic diagram illustrating simulation results with a reception coupler and a transmission coupler that obtain a gain 201 in FIG. 2 in a case where a signal line in the reception coupler and a signal line in the transmission coupler directly face each other at respective center positions and in a case where they are shifted from each other by 0.5 mm.

FIG. 4 is a schematic diagram illustrating an overview configuration of a wireless communication system according to a second exemplary embodiment.

FIG. 5A is a plan view illustrating an example of a positional relationship between a signal line in a reception coupler and a conductor on a ground surface.

FIG. 5B is a plan view illustrating another example of a positional relationship between the signal line in the reception coupler and the conductor on the ground surface.

FIG. 6A is a characteristic diagram illustrating simulation results indicating a reflection characteristic (S11) when an electric signal is input to the signal line with the positional relationship illustrated in FIG. 5A.

FIG. 6B is a characteristic diagram illustrating simulation results indicating a reflection characteristic (S11) when an electric signal is input to the signal line with the positional relationship illustrated in FIG. 5B.

FIG. 7A is a plan view illustrating another example of holes formed in the ground surface.

FIG. 7B is a plan view illustrating still another example of holes formed in the ground surface.

FIG. 8 is a schematic diagram illustrating an overview configuration of a wireless communication system according to a third exemplary embodiment.

FIG. 9 is a characteristic diagram illustrating simulation results indicating transmission efficiency in wireless power transmission in a case where a coupler for wireless power transmission and a coupler for wireless communication are disposed in proximity to each other.

FIG. 10 is a characteristic diagram illustrating simulation results regarding a gain of a reception coupler in a case where a coupler in which holes are formed in a ground surface is used as a communication coupler and a size of each hole is changed according to a fourth exemplary embodiment.

### DESCRIPTION OF THE EMBODIMENTS

### —Basic Configuration of Wireless Communication Apparatus in Various Exemplary Embodiments—

To specifically disclose various exemplary embodiments, a basic configuration of a wireless communication apparatus in the various exemplary embodiments will be described.

The wireless communication apparatus according to the various exemplary embodiments includes a coupler that is electromagnetically coupled to and performs wireless communication with another wireless communication apparatus. The coupler includes a signal line and a ground surface with a conductor, and the ground surface has a configuration of not having the conductor in part of a region overlapping with the signal line in a plan view. In a case where the conductor is formed on the whole of the ground surface, using a coupler with a thin circuit board to reduce the size of the coupler makes the ground surface and the signal line proximate to each other and strengthens electromagnetic coupling, which leaves no alternative but to design the signal line to be small in width. As a result, in a case where a lateral shift occurs, for example, at the center positions of couplers in a width direction, there is a possibility that an issue of weakening of electromagnetic coupling occurs. Consequently, there is a possibility that stable communication cannot be performed.

In the present disclosure, a missing portion in which the conductor is missing is formed on the ground surface, which creates a portion without the conductor in part of the region overlapping with the signal line in the plan view.

With this configuration, electromagnetic coupling between the ground surface and the signal line in the couplers weakens in comparison with a case where the conductor is formed on the whole of the ground surface, which makes it possible to design the signal line to have a large width. Employing the signal line having the large line width strengthens electromagnetic coupling to a coupler of another wireless communication apparatus. This makes it possible to obtain a large gain and prevents a decrease in gain even in a case where the couplers are disposed to face each other in a state of being shifted at respective center positions in the width direction. As a result, the wireless communication apparatus using the compact coupler that can perform stable communication is implemented.

As a specific example of the ground surface, a plurality of polygonal holes is periodically formed, as the missing portions in which the conductor is missing, along a longitudinal direction of the signal line and, furthermore, along a direction intersecting with the longitudinal direction of the signal line. Forming holes in a polygon shape or in a size adjusted as appropriate in the conductor on the ground surface makes it possible to obtain a sufficient gain suitable for the compact coupler in the wireless communication apparatus. In this case, the plurality of holes may not be formed all over the ground surface and the conductor may be formed on the whole surface in a predetermined region of the ground surface. Appropriately adjusting and designing the region in which the plurality of holes is formed in the ground surface secures the strength of the ground surface.

Additionally, the ground surface can have a configuration in which the conductor intersects with the signal line in a region overlapping with the signal line. In a case where there is a plurality of portions where the conductor intersects with the signal line in the plan view, a reflection characteristic of the signal line is more enhanced as a connecting portion between adjacent intersection portions (a portion that is horizontal to the longitudinal direction of the signal line) is smaller. A state where no connecting portion exists, that is, a state where the conductor that exits in the region overlapping with the signal line in the plan view is divided is the most desirable state to enhance the reflection characteristic. In this manner, appropriately adjusting and designing the portion of the conductor intersecting with the signal line depending on the state of the wireless communication apparatus makes it possible to achieve an excellent reflection characteristic of the signal line and obtain a large gain.

The wireless communication apparatus according to the various exemplary embodiments is applied to a wireless communication system. The wireless communication system includes a first wireless communication apparatus and a second wireless communication apparatus. The first wireless communication apparatus includes a first coupler. The second wireless communication apparatus includes a second coupler that is electromagnetically coupled to the first coupler and performs wireless communication with the first wireless communication apparatus. The first coupler includes a first signal line and a first ground surface including a first conductor, and the second coupler includes a second signal line and a second ground surface including a second conductor. In the wireless communication system according to the various exemplary embodiments, one or both of the following configurations (1) and (2) are satisfied.
(1) The first ground surface does not have the first conductor in part of a region overlapping with the first signal line in the plan view.
(2) The second ground surface does not have the second conductor in part of a region overlapping with the second signal line in the plan view.
   Employing the configuration (1) or (2) strengthens electromagnetic coupling between the first coupler in the first wireless communication apparatus and the second coupler in the second wireless communication apparatus, makes it possible to obtain a large gain, and prevents a decrease in gain even in a case where the first and second couplers are disposed to face each other in a state of being shifted at their center positions in the width direction. Employing the configurations (1) and (2) makes it possible to obtain a larger gain. In this manner, according to the various exemplary embodiments, the wireless communication system including the first wireless communication apparatus and the second wireless communication apparatus each using the compact coupler that can perform stable communication can be implemented.
   —Specific Description about Various Exemplary Embodiments—

Various exemplary embodiments to which the present technology is applicable will be described below in detail with reference to drawings. In the following description, common members are denoted by common reference numbers throughout a plurality of drawings. Hence, the common members will be described with cross-reference to the plurality of drawings, and a repetitive description of the members denoted by the common reference numbers will be omitted as appropriate.

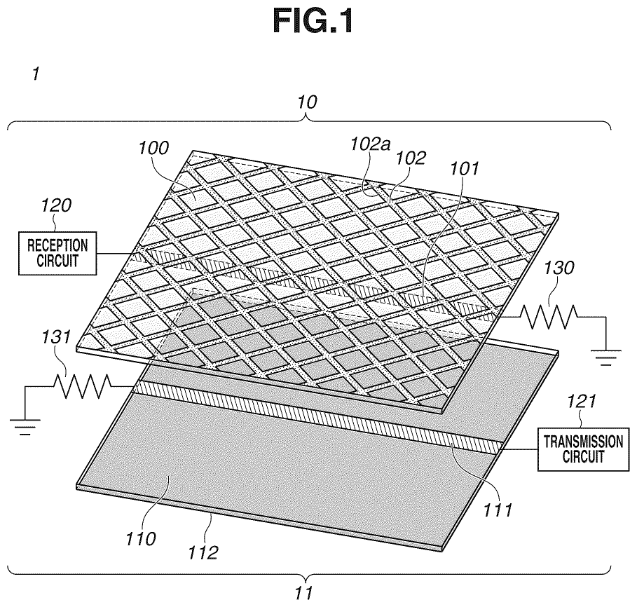

FIG. 1 is a schematic diagram illustrating an overview configuration of a wireless communication system 1 according to a first exemplary embodiment.

The wireless communication system 1 includes, as wireless communication apparatuses, a reception apparatus 10 that performs wireless reception and a transmission apparatus 11 that performs wireless transmission. The reception apparatus 10 and the transmission apparatus 11 are wireless communication apparatuses that perform mutual wireless communication using electromagnetic coupling. The reception apparatus 10 includes a reception coupler 100, a reception circuit 120, and a terminator 130. The transmission apparatus 11 includes a transmission coupler 110 that is to be electromagnetically coupled to the reception coupler 100, a transmission circuit 121, and a terminator 131. The reception coupler 100 and the transmission coupler 110 are each configured as a so-called microstrip line.

The reception coupler 100 is, for example, formed on a flexible printed circuit board, and includes a signal line 101 on one of the principal surfaces of the flexible printed circuit board and a ground surface 102 on the other of the principal surfaces of the flexible printed circuit board. The ground surface 102 serves as a reference potential for the signal line 101. The reception circuit 120 is electrically connected to one end of the signal line 101. The reception circuit 120 processes an electric signal received by the signal line 101. The terminator 130 is electrically connected to the other end of the signal line 101, to which the reception circuit 120 is not connected. The terminator 130 performs impedance matching termination on the signal line 101.

The transmission coupler 110 is, for example, formed on a flexible printed circuit board, and includes a signal line 111 on one of the principal surfaces of the flexible printed circuit board and a ground surface 112 on the other of the principal surfaces of the flexible printed circuit board. The ground surface 112 serves as a reference potential for the signal line 111. The transmission circuit 121 is electrically connected to one end of the signal line 111. The transmission circuit 121 generates a transmission signal and inputs the transmission signal to the signal line 111. The terminator 131 is electrically connected to the other end of the signal line 111, to which the transmission circuit 121 is not connected. The terminator 131 performs impedance matching termination for the signal line 111.

Subsequently, details of the reception coupler 100 are described.

The signal line 101 is made of a conductor such as copper (Cu) or aluminum (Al), which is a metal material having excellent conductivity, and has a line width W1 in a width direction. The ground surface 102 includes a conductor that serves as a reference potential for the signal line 101. As the conductor, for example, Cu or Al is used. In the reception coupler 100, missing portions in which the conductor is missing are formed in the ground surface 102, which creates portions without the conductor in part of the region overlapping with the signal line 101 in the plan view. In the present exemplary embodiment, holes 102a, which are gaps in which the conductor is missing, are formed in the ground surface 102, and part of the holes 102a serves as the portions without the conductor in part of the region overlapping with the signal line 101 in the plan view, and as a result, the above-mentioned configuration is implemented. Specifically, the ground surface 102 is provided with the conductor in a meshed pattern and has a plurality of rhombic holes 102a that is periodically arrayed in a substantially horizontal direction (hereinafter simply referred to as a horizontal direction) along the longitudinal direction of the signal line 101 and in a substantially vertical direction (hereinafter simply referred to as a vertical direction) intersecting with the longitudinal direction.

A maximum size of the holes 102a in the ground surface 102 is determined by the line width W1 and an upper limit of transmission frequencies. Specifically, in a case where the upper limit of frequencies is desired to be 40 GHz, the holes 102a each have a size that is approximately 0.5 square millimeter (mm²) or less. In a case where the upper limit of frequencies is desired to be 35 GHz, the holes 102a each have a size that is approximately from 0.5 mm² to 0.85 mm². In a case where the upper limit of frequencies is desired to be 25 GHZ, the holes 102a each have a size that is approximately from 0.85 mm² to 1.45 mm².

Subsequently, details of the transmission coupler 110 are described.

The signal line 111 is made of, for example, a conductor such as Cu or Al, and has a line width W2 in the width direction. The ground surface 112 has a configuration in which the conductor, such as Cu or Al, serving as a reference potential for the signal line 111, is formed on the whole surface.

The wireless communication system 1 according to the present exemplary embodiment performs wireless communication using electromagnetic coupling between the reception coupler 100 and the transmission coupler 110. While the wireless communication system 1 is illustrated in FIG. 1 as an example in which the reception coupler 100 and the transmission coupler 110 have substantially identical lengths, the transmission coupler 110 may be, for example, larger in length than the reception coupler 100. In this case, the reception coupler 100 may be configured to move relatively along the transmission coupler 110 while keeping a certain distance above the transmission coupler 110. The movement is implemented by a movement control apparatus such as a motor. The movement control apparatus is not illustrated. Alternatively, the reception coupler 100 may be larger in length than the transmission coupler 110. In this case, the transmission coupler 110 may be configured to move relatively along the reception coupler 100 by the movement control apparatus while keeping a certain distance above the reception coupler 100.

In the reception coupler 100 according to the present exemplary embodiment, the ground surface 102 serving as the reference potential has the holes 102a, which weakens electromagnetic coupling to the signal line 101. Therefore, in comparison with a case where the ground surface has no hole, it is possible to increase the line width W1. Using the signal line 101 with the larger line width W1 in the reception coupler 100 makes it possible to obtain a larger gain in electromagnetic coupling to the transmission coupler 110. Additionally, electromagnetic coupling between the reception coupler 100 and the transmission coupler 110 reaches its maximum level in a case where the center of the signal line 101 and the center of the signal line 111 in the width direction directly face each other at a substantially identical position. Hence, using the signal line 101 with the large line width W1 makes it possible to obtain a large gain even in a case where the signal line 101 and the signal line 111 face each other in a state where their centers are shifted from each other. In a case where the holes 102a are formed in the ground surface 102, whereas no hole is formed in the ground surface 112, and a distance between the signal line 101 and the ground surface 102 and a distance between the signal line 111 and the ground surface 112 are substantially equal, it is possible to make the line width W1 larger than the line width W2.

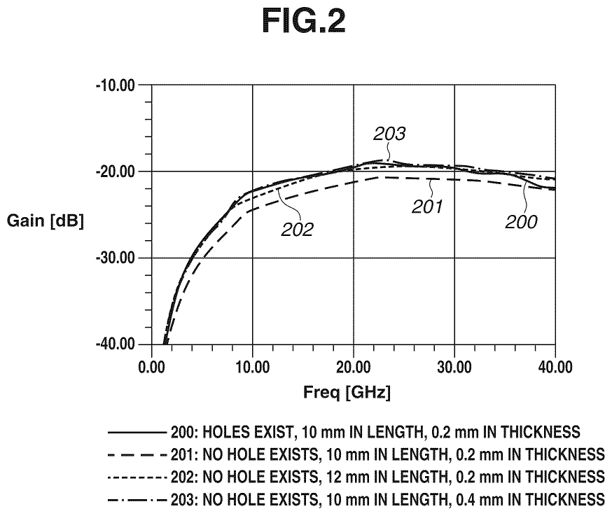

FIG. 2 is a characteristic diagram illustrating simulation results of a gain obtained in the reception coupler with use of the transmission line in which holes are formed in the ground surface. The simulation in FIG. 2 has been conducted on the assumption that the transmission line with characteristic impedance of approximately 50Ω is mounted on a general Flame Retardant Type 4 (FR4) circuit board.

In a case where holes as illustrated in FIG. 1 are formed in the ground surface and a distance between the signal line and the ground surface is 0.2 millimeter (mm), the transmission line with the characteristic impedance of approximately 50Ω is implemented by making the line width 0.6 mm. In a case where no hole is formed in the ground surface and the distance between the signal line and the ground surface is 0.2 mm, the transmission line with the characteristic impedance of approximately 50Ω is implemented by making the line width 0.35 mm.

A gain 200 represents a simulation result obtained in a case where the reception coupler in which rhombic holes are periodically formed in the ground surface and the transmission coupler in which no hole is formed in the ground surface face each other as illustrated in FIG. 1. The transmission coupler and the reception coupler each have a line length of 10 mm. A gain 201 represents a simulation result obtained in a case where couplers in which no hole is formed in the ground surface are disposed to face each other, the distance between the transmission line and the ground surface is 0.2 mm, and the line width is 0.35 mm. The transmission coupler and the reception coupler each have a line length of 10 mm.

As illustrated in FIG. 2, it is found that the gain 200 is larger than the gain 201, and forming the holes in the ground surface increases a gain without changing the line length and the distance between the transmission line and the ground surface.

A conceivable method for increasing electromagnetic coupling between the reception coupler and the transmission coupler without forming holes in the ground surface is to increase the line length of the signal line to increase a gain. A gain 202 represents a simulation result obtained in a case where couplers in which no hole is formed in the ground surface are disposed to face each other, the distance between the signal line and the ground surface is 0.2 mm, the line width is 0.35 mm and the line length is 12 mm. The gain 202 is substantially equal to the gain 200, and it is found that increasing the line length makes it possible to obtain electromagnetic coupling approximately equal to that in a case where holes are formed in the ground surface. This means that forming the holes in the ground surface makes it possible to decrease the line length and, as a result, reduce the surface area of each coupler.

Another conceivable method for increasing electromagnetic coupling between the reception coupler and the transmission coupler without forming holes in the ground surface is to increase the distance between the signal line and the ground surface, thereby increasing the line width. A gain 203 represents a simulation result obtained in a case where couplers in which no hole is formed in the ground surface are disposed to face each other, the distance between the signal line and the ground surface is 0.4 mm, the line width is 0.6 mm and the line length is 10 mm. The gain 203 is substantially equal to the gain 200, and it is found that increasing the distance between the signal line and the ground surface makes it possible to obtain electromagnetic coupling that is equivalent to that in a case where the holes are formed in the ground surface. This means that forming the holes in the ground surface makes it possible to decrease the distance between the signal line and the ground surface, thereby reducing the thickness of each coupler.

The above-mentioned simulation results show that forming the holes in the ground surface makes it possible to reduce the size of each coupler while obtaining a large gain. Based on these simulation results, in the reception apparatus 10 according to the present exemplary embodiment, for example, forming the holes 102a in the ground surface 102 in the reception coupler 100 as illustrated in FIG. 1 makes it possible to obtain a large gain with the compact reception coupler 100.

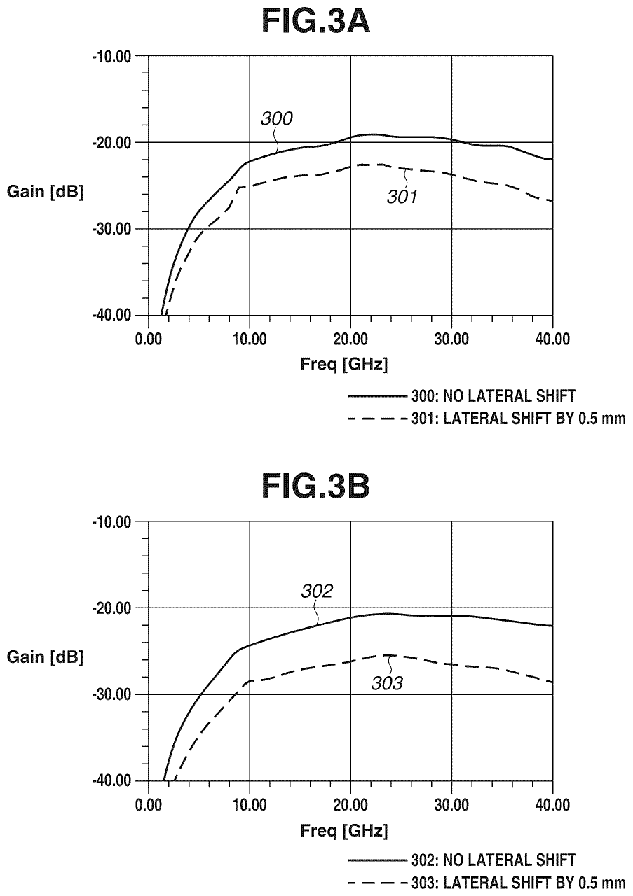

FIGS. 3A and 3B are characteristic diagrams each illustrating simulation results of a gain in a case where the signal line in the reception coupler and the signal line in the transmission coupler directly face each other at respective center positions and in a case where they are shifted from each other by 0.5 mm. FIG. 3A illustrates a result of simulation conducted under a condition that is identical to that when the gain 200 is obtained as illustrated in FIG. 2. FIG. 3B illustrates a result of simulation conducted under a condition that is identical to that when the gain 201 is obtained as illustrated in FIG. 2.

A gain 300 represents a simulation result obtained in a case where the signal line in the reception coupler and the signal line in the transmission coupler face each other in a state where the center positions thereof in the width direction are aligned. A gain 301 represents a simulation result obtained in a case where the signal line in the reception coupler and the signal line in the transmission coupler face each other in a state where the center positions thereof in the width direction are laterally shifted from each other by 0.5 mm.

As illustrated in FIG. 3A, for example, the gain 301 is smaller than the gain 300 by approximately 3.3 dB at 20 GHz.

A gain 302 is a simulation result obtained in a case where the signal line in the reception coupler and the signal line in the transmission coupler face each other in a state where the center positions thereof in the width direction are aligned. A gain 303 is a simulation result obtained in a case where the signal line in the reception coupler and the signal line in the transmission coupler face each other in a state where the center positions thereof in the width direction are laterally shifted from each other by 0.5 mm. As illustrated in FIG. 3B, for example, the gain 303 is smaller than a gain 304 by approximately 4.2 dB at 20 GHz.

The above-mentioned simulation results show that using the coupler with a reduced size in which the holes are formed in the ground surface makes it possible to obtain an effect of increasing resistance to a lateral shift between the reception coupler and the transmission coupler.

In the reception apparatus 10 in the present exemplary embodiment, based on these simulation results, for example, forming the holes 102a in the ground surface 102 of the reception coupler 100 as illustrated in FIG. 1 prevents a deterioration of performance even if a lateral shift occurs between the reception coupler 100 and the transmission coupler 110.

As illustrated above, in the present exemplary embodiment, by forming the holes in the ground surface as appropriate even in a case where the reception coupler that is electromagnetically coupled to the transmission coupler is mounted on a small circuit board, it is possible to increase the line width, obtain a large gain, and increase resistance to a lateral shift. As a result, the wireless communication apparatus using the compact coupler that can perform stable communication, and the wireless communication system are implemented.

While the description has been given of the configuration in which the transmission coupler 110 includes the signal line 111 and the ground surface 112 in the present exemplary embodiment, the transmission coupler 110 may be, for example, a coupler that is inductively coupled to another coupler such as a patch coupler. In this case, the terminator 131 may be omitted.

In the present exemplary embodiment, the description has been given of the configuration in which the holes 102a are formed in the ground surface 102 of the reception coupler 100 and no hole is formed in the ground surface 112 of the transmission coupler 110. Instead of the configuration, a configuration in which no hole is formed in the ground surface 102 and holes similar to the holes 102a are formed in the ground surface 112, or a configuration in which holes similar to the holes 102a are formed both in the ground surface 102 and the ground surface 112 may be employed. Even in this case, the wireless communication apparatus using the compact coupler that can perform stable communication, and the wireless communication system are implemented similarly to the configuration in FIG. 1. In particular, in a case where the holes are formed both in the ground surface 102 and the ground surface 112, the line width of each of the signal lines 101 and 111 is increased, whereby a larger gain is obtained and resistance to a lateral shift is increased.

While the description has been given of the configuration in which each of the reception coupler 100 and the transmission coupler 110 is a microstrip line, each of the reception coupler 100 and the transmission coupler 110 may be a coplanar line including a ground guard or a differential line.

In a case where the coplanar line including the ground guard is employed as a coupler, the coupler is formed, for example, on a flexible printed circuit board. A signal line is provided on one of the principal surfaces of the circuit board and a pair of ground guards is provided on both sides of the signal line. A ground surface serving as a reference potential is provided on the other of the principal surfaces of the circuit board. In this ground surface, a plurality of polygonal holes is formed in a conductor similarly to the ground surface in the various exemplary embodiments of the present disclosure. Even in this case, forming the holes in the ground surface as appropriate makes it possible to increase the line width of the signal line, obtain a large gain, and increase resistance to a lateral shift similarly to the various exemplary embodiments. As a result, the wireless communication apparatus using the compact coupler of the coplanar line type that can perform stable communication, and the wireless communication system are implemented.

In a case where the differential line is employed as a coupler, the coupler is formed, for example, on a flexible printed circuit board. A pair of signal lines arrayed in parallel is provided on one of the principal surfaces of the circuit board.

A ground surface serving as a reference potential is provided on the other of the principal surfaces of the circuit board. In this ground surface, a plurality of polygonal holes is formed in a conductor similarly to the ground surface in the various exemplary embodiments of the present disclosure. Even in this case, forming the holes in the ground surface as appropriate makes it possible to increase the line width of the signal line, obtain a large gain, and increase resistance to a lateral shift similarly to the various exemplary embodiments. As a result, the wireless communication apparatus using the compact coupler of the differential line type that can perform stable communication, and the wireless communication system are implemented.

Additionally, the transmission line in the coupler in which the holes are formed in the ground surface is characterized in that a transmission loss is larger than that of the transmission line in the coupler in which no hole is formed in the ground surface. Hence, for example, in a case where the transmission coupler is longer than the reception coupler in length, it is desirable to employ a combination of the configuration in which holes are formed in the ground surface of the reception coupler and the configuration in which no hole is formed in the ground surface of the transmission coupler.

According to the present exemplary embodiment, even if the compact reception coupler and the compact transmission coupler are designed so as to be fitted in a space for mounting a communication coupler, strong electromagnetic coupling between the reception coupler and the transmission coupler is obtained, whereby the communication apparatus that can perform stable communication is implemented.

In a second exemplary embodiment, disclosed are a wireless communication apparatus in which a plurality of holes is periodically arrayed and formed in a ground surface of a coupler and a wireless communication system, similarly to the first exemplary embodiment. However, the second exemplary embodiment is different from the first exemplary embodiment in a shape of each hole formed in the ground surface.

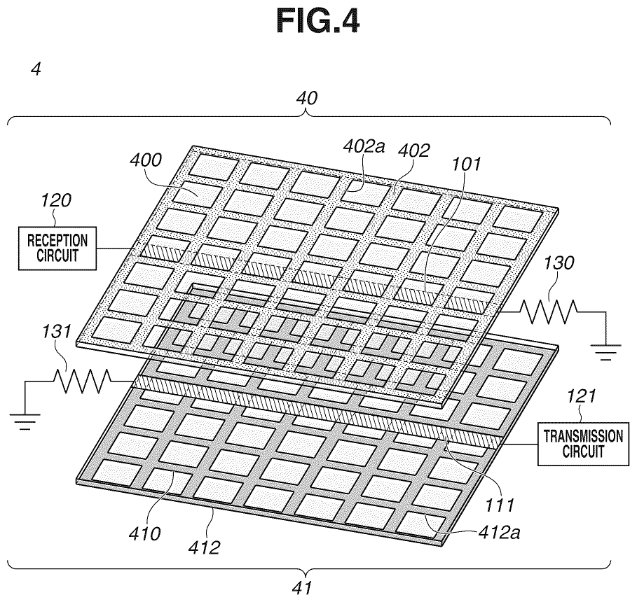

FIG. 4 is a schematic diagram illustrating an overview configuration of a wireless communication system 4 according to the second exemplary embodiment. In FIG. 4, a part that is similar to that in the configuration according to the first exemplary embodiment in FIG. 1 is denoted by an identical reference sign, and a detailed description thereof is omitted.

The wireless communication system 4 includes, as wireless communication apparatuses, a reception apparatus 40 that performs wireless reception and a transmission apparatus 41 that performs wireless transmission. The reception apparatus 40 and the transmission apparatus 41 are wireless communication apparatuses that perform mutual wireless communication using electromagnetic coupling. The reception apparatus 40 includes a reception coupler 400, the reception circuit 120, and the terminator 130. The transmission apparatus 41 includes a transmission coupler 410 that is electromagnetically coupled to the reception coupler 400, the transmission circuit 121, and the terminator 131. The reception coupler 400 and the transmission coupler 410 are each configured as a so-called microstrip line.

The reception coupler 400 is, for example, formed on a flexible printed circuit board, and includes the signal line 101 on one of the principal surfaces of the flexible printed circuit board and a ground surface 402 on the other of the principal surfaces of the flexible printed circuit board. The ground surface 402 serves as a reference potential for the signal line 101. The transmission coupler 410 is, for example, formed on a flexible printed circuit board, and includes the signal line 111 on one of the principal surfaces of the flexible printed circuit board and a ground surface 412 on the other of the principal surfaces of the flexible printed circuit board.

Subsequently, details of the reception coupler 400 are described.

The signal line 101 has the line width W1 in the width direction. The ground surface 402 includes a conductor that serves as a reference potential for the signal line 101. The reception coupler 400 has a configuration in which the ground surface 402 does not have the conductor in part of a region overlapping with the signal line 101 in a plan view. In the reception coupler 400, missing portions in which the conductor is missing are formed on the ground surface 402, which creates portions without the conductor in part of the region overlapping with the signal line 101 in the plan view. In the present exemplary embodiment, holes 402a, which are gaps in which the conductor is missing, are formed in the ground surface 402, and part of the holes 402a serves as a portion without the conductor in part of the region overlapping with the signal line 101 in the plan view, and as a result, the above-mentioned configuration is implemented. Specifically, the ground surface 402 is provided with the conductor in a meshed pattern. The ground surface 402 includes a plurality of quadrangle holes 402a periodically arrayed in each of a direction substantially horizontal (hereinafter simply referred to as horizontal) to the longitudinal direction of the signal line 101 and a direction substantially vertical (hereinafter simply referred to as vertical) to the longitudinal direction of the signal line 101. Each hole 402a has sides horizontal to the signal line 101 and sides vertical to the signal line 101.

A maximum size of the holes 402a in the ground surface 402 is determined based on the line width W1 and an upper limit of transmission frequencies similarly to the size of the hole 102a in the ground surface 102 according to the first exemplary embodiment. Specifically, in a case where the upper limit of frequencies is desired to be 40 GHZ, the hole 402a has a size that is approximately 0.5 mm² or less. In a case where the upper limit of frequencies is desired to be 35 GHz, the hole 402a has a size that is approximately from 0.5 mm² to 0.85 mm². In a case where the upper limit of frequencies is desired to be 25 GHz, the hole 402a has a size that is approximately from 0.85 mm² to 1.45 mm².

Subsequently, details of the transmission coupler 410 are described.

The signal line 111 has the line width W2 in the width direction. The ground surface 412 includes a conductor that serves as a reference potential for the signal line 111. The transmission coupler 410 has a configuration in which the ground surface 412 does not have the conductor in part of a region overlapping with the signal line 111 in the plan view. In the transmission coupler 410, missing portions in which the conductor is missing are formed on the ground surface 412, which creates portions without the conductor in part of the region overlapping with the signal line 101 in the plan view. In the present exemplary embodiment, holes 412a, which are gaps in which the conductor is missing, are formed in the ground surface 412, and part of the holes 412a serves as a portion without the conductor in part of the region overlapping with the signal line 111 in the plan view, and as a result, the above-mentioned configuration is implemented. Specifically, the ground surface 412 includes the plurality of quadrangle holes 412a that is periodically arrayed in the horizontal direction along the longitudinal direction of the signal line 111 and in the vertical direction intersecting with the longitudinal direction. Two sides of the holes 412a are substantially horizontal along the longitudinal direction of the signal line 111, and the other two sides thereof are substantially vertical and intersect with the longitudinal direction of the signal line 111.

A maximum size of the holes 412a in the ground surface 412 is determined by the line width W2 and an upper limit of transmission frequencies similarly to the maximum size of the hole 102a in the ground surface 102 according to the first exemplary embodiment. Specifically, in a case where the upper limit of frequencies is desired to be 40 GHz, the hole 412a has a size that is approximately 0.5 mm² or less. In a case where the upper limit of frequencies is desired to be 35 GHZ, the hole 412a has a size that is approximately from 0.5 mm² to 0.85 mm². In a case where the upper limit of frequencies is desired to be 25 GHz, the hole 412a has a size that is approximately from 0.85 mm² to 1.45 mm².

In the reception coupler 400 and the transmission coupler 410 according to the present exemplary embodiment, similarly to the reception coupler 100 described in the first exemplary embodiment, the holes 402a and 412a are formed in the ground surfaces 402 and 412, respectively, which both serve as reference potentials. Therefore, in comparison with a case where no hole exits in the ground surface, it is possible to increase the line width W1 of the signal line 101 and the line width W2 of the signal line 111. This strengthens electromagnetic coupling between the reception coupler 400 and the transmission coupler 410 and makes it possible to obtain a large gain even with the compact couplers and further obtain a sufficient gain even if shifting occurs between the signal line 101 and the signal line 111 at the respective center positions.

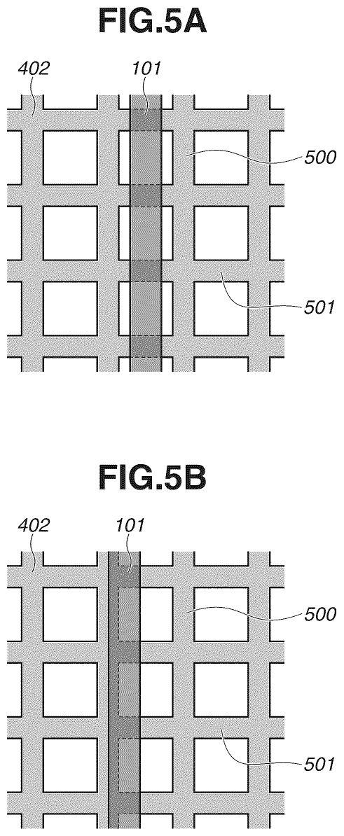

FIGS. 5A and 5B are plan views each illustrating the reception coupler 400 when viewed in a direction vertical to the ground surface 402.

A first portion 500 is a portion of the mesh-like conductor on the ground surface 402, which extends along the signal line 101, that is, in a direction horizontal to the longitudinal direction of the signal line 101. A second portion 501 is a portion of the mesh-like conductor on the ground surface 402, which intersects with the signal line 101, that is, in a direction orthogonal to the longitudinal direction of the signal line 101.

FIG. 5A illustrates a case where the signal line 101 and the first portion 500 of the ground surface 402 are set so as not to overlap with each other. FIG. 5B illustrates a case where the signal line 101 and the first portion 500 of the ground surface 402 are set so as to overlap with each other.

As illustrated in FIG. 5A, the effect of increasing the line width W1 by weakening electromagnetic coupling between the signal line 101 and the ground surface 402 and strengthening electromagnetic coupling between the reception coupler 400 and the transmission coupler 410 is produced more effectively in a case where the signal line 101 has a larger portion overlapping with the second portion 501 of the ground surface 402. The same applies to the transmission coupler 410.

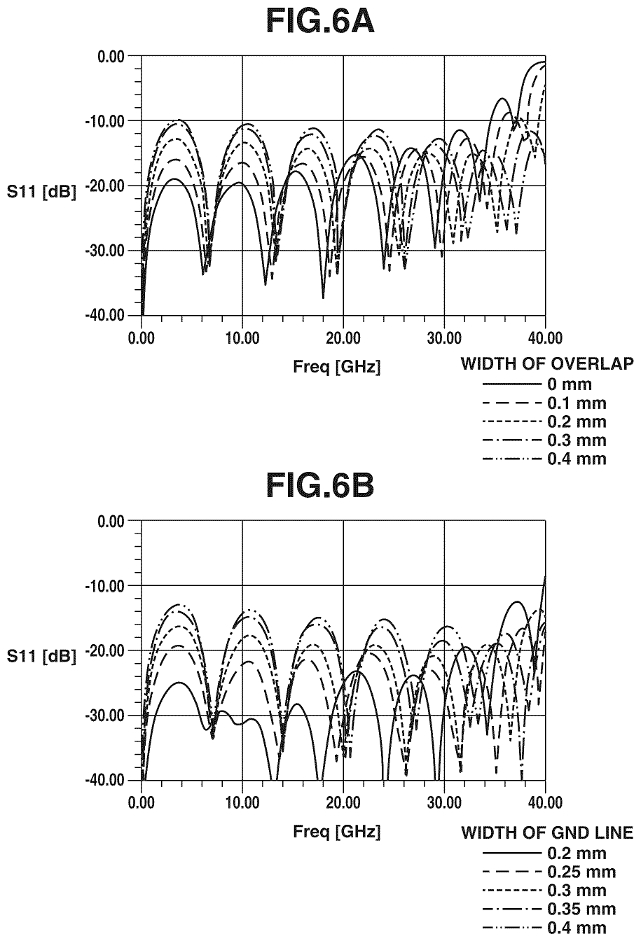

FIGS. 6A and 6B are characteristic diagrams each illustrating simulation results indicating a reflection characteristic (S11) when an electric signal is input to the signal line 101, depending on how the signal line 101 and the ground surface 402 overlap with each other.

FIG. 6A illustrates a change in S11 depending on a width of an overlap between the signal line 101 and the first portion 500 in a state where they overlap with each other at an end of the signal line 101 in the width direction while the line width W1 and the width of the first portion 500 are maintained at constant values, as illustrated in FIG. 5B. FIG. 6A indicates that S11 is greater as a width of the overlap becomes larger.

FIG. 6B illustrates a change in S11 in a case where the signal line 101 and the first portion 500 overlap each other in a state of being aligned at respective center portions in the width direction while the line width W1 is maintained at a constant value, and the width of the first portion 500 changes. FIG. 6B indicates that S11 is greater as the width of the overlap becomes larger.

The above-mentioned simulation results indicate the following facts. That is, in a case where the holes are formed in the ground surface and the conductor that remains on the ground surface includes a portion horizontal to the signal line and a portion vertical to the signal line, the reflection characteristic of the signal line is increased as an amount of the overlap between the signal line and the portion horizontal to the signal line (an amount of a portion connecting intersection portions between the conductor and the signal line) is small. Based on these simulation results, the wireless communication system 4 in the present exemplary embodiment is desirably configured as follows. In each of the reception apparatus 40 and the transmission apparatus 41, for example, the signal line and the ground surface are disposed so that the signal line and only the second portion 501 overlap with each other (the conductor that exits in the region overlapping with the signal line is divided) in the plan view as illustrated in FIG. 5A. Additionally, even in a case where the signal line and the first portion 500 overlap with other in the plan view due to design constraints or the like as illustrated in FIG. 5B, the signal line and the ground surface are disposed so that the overlap is reduced as much as possible.

As described above, in the present exemplary embodiment, a positional relationship between the transmission line and the ground surface in the plan view is designed as the above-mentioned positional relationship. With this configuration, even in a case where the reception coupler and the transmission couplers are configured to use a small circuit board, it is possible to increase the line width of the signal line, obtain a large gain, and increase resistance to a lateral shift.

As a result, the wireless communication apparatus using the compact coupler that can perform stable communication, and the wireless communication system are implemented.

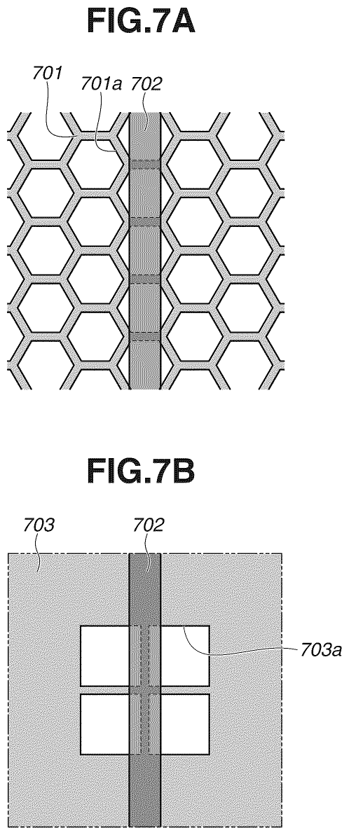

While the description has been given of the example in the case where the quadrangle holes each having sides horizontal to the longitudinal direction of the signal line and sides vertical to the longitudinal direction of the signal line are formed in the ground surface in the present exemplary embodiment, the shape of the holes formed in the ground surface may be a polygon with four or more sides. FIG. 7A illustrates a case where hexagonal holes 701a are periodically formed in a ground surface 701 of at least one of the reception apparatus 40 and the transmission apparatus 41. In this manner, in a case where the conductor included in the ground surface 701 has a large line width, the portion horizontal to a signal line 702 is regarded to exist in the conductor. Thus, the signal line and the ground surface are desirably designed to have a positional relationship similar to that in the present exemplary embodiment described above.

While the description has been given of the example in the case where the holes are periodically formed all over the ground surface in the present exemplary embodiment, the holes may be formed in part of the ground surface. FIG. 7B illustrates a case where, for example, four quadrangle holes 703a each having sides horizontal to the longitudinal direction of the signal line 702 and sides vertical to the longitudinal direction of the signal line 702 are formed in a middle portion of a ground surface 703 of a coupler of at least one of the reception apparatus 40 and the transmission apparatus 41. In consideration of increasing the strength of the ground surface 703 and other factors, the conductor is formed on the whole surface in a region excluding the middle portion of the ground surface 703. In this manner, even if the holes formed in the ground surface are not formed in the whole of the ground surface, the ground surface may have a configuration in which the conductor is not included in part of the region overlapping with the signal line in the plan view.

According to the present exemplary embodiment, even if the compact transmission coupler and the compact reception coupler are designed so as to be fitted in a space for mounting a communication coupler, strong electromagnetic coupling between the reception coupler and the transmission coupler is obtained, whereby the communication apparatus that can perform stable communication is implemented.

In a third exemplary embodiment, disclosed are a wireless communication apparatus in which a plurality of holes is periodically arrayed and formed in a ground surface of a wireless communication coupler, and a wireless communication system, similarly to the first and second exemplary embodiments. However, the third exemplary embodiment is different from the first and second exemplary embodiments in that it further includes a wireless power transmission coupler.

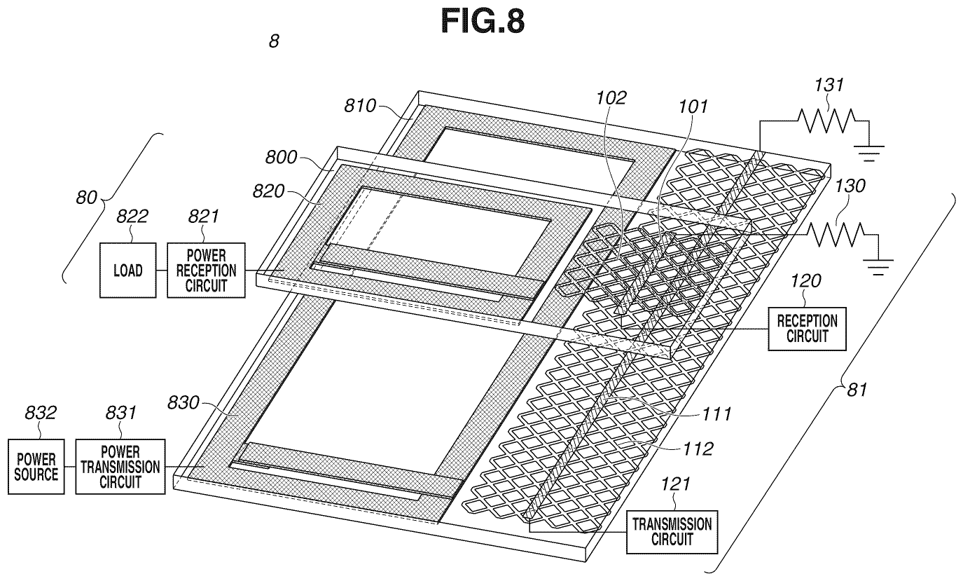

FIG. 8 is a schematic diagram illustrating an overview configuration of a wireless communication system 8 according to the third exemplary embodiment. In FIG. 8, a part that is similar to that in the configuration illustrated in FIG. 1 is denoted by an identical reference sign, and a detailed description thereof is omitted.

The wireless communication system 8 includes, as wireless communication apparatuses, a reception apparatus 80 and a transmission apparatus 81. The reception apparatus 80 is a wireless communication apparatus that can simultaneously perform wireless communication using electromagnetic coupling and wireless power transmission using electromagnetic induction, magnetic field resonance, or electric field coupling between the reception apparatus 80 and the transmission apparatus 81. The reception apparatus 80 includes a reception coupler 800, the reception circuit 120, the terminator 130, a power reception circuit 821, and a load 822. The transmission apparatus 81 includes a transmission coupler 810 that is electromagnetically coupled to the reception coupler 800, the transmission circuit 121, the terminator 131, a power transmission circuit 831, and a power source 832.

The reception coupler 800 includes the signal line 101, the ground surface 102, and a winding wire 820 whose number of turns is one or more. The reception coupler 800 is formed by, for example, a printed circuit board. The ground surface 102 serves as a reference potential for the signal line 101. The winding wire 820 is a coupler that receives power. The power reception circuit 821 is constituted by a known rectification circuit. The power reception circuit 821 converts power received by the winding wire 820 and supplies the power to the load 822. The load 822 is, for example, a motor that operates with supplied power.

The transmission coupler 810 includes the signal line 111, the ground surface 112, and a winding wire 830 whose number of turns is one or more. The transmission coupler 810 is formed by, for example, a printed circuit board. The ground surface 112 serves as a reference potential for the signal line 111. The winding wire 830 is a coupler that transmits power to the winding wire 820. The power transmission circuit 831 is constituted by a known switching circuit. The power transmission circuit 831 converts a voltage supplied from the power source 832 into a frequency of a clock signal and supplies the frequency to the winding wire 830.

In the wireless communication system 8 according to the present exemplary embodiment, in a case where the transmission coupler 810 is longer than the reception coupler 800 in a direction along the transmission line, the reception coupler 800 may be configured to move relatively along the transmission coupler 810 while keeping a certain distance above the transmission coupler 810. The movement is implemented by a movement control apparatus, such as a motor. The reception coupler 800 may be longer than the transmission coupler 810 in the direction along the transmission line. In this case, the transmission coupler 810 may be configured to move relatively along the reception coupler 800 by the movement control apparatus while keeping a certain distance above the reception coupler 800. Alternatively, the length of the reception coupler 800 may be substantially equal to the length of the transmission coupler 810. In this case, the reception coupler 800 and the transmission coupler 810 may be used without the movement control apparatus.

The transmission efficiency of a coupler to be used in wireless power transmission deteriorates due to the existence of metal around the coupler.

This is because, when the metal exists near the power transmission coupler, a magnetic flux that is generated from the power transmission coupler generates eddy current on the surface of the metal, and the eddy current is converted into heat. To prevent this, in a case where a wireless power transmission coupler and a wireless communication coupler are disposed, it is desirable to dispose the wireless power transmission coupler and the wireless communication coupler by keeping them away from each other as much as possible. However, there is a case where the wireless power transmission coupler and the wireless communication coupler may be disposed in proximity due to a constraint on a mounting space or the like, and as a result, only low transmission efficiency can be achieved.

In the reception coupler 800 and the transmission coupler 810 according to the present exemplary embodiment, forming the holes 102a and 112a in the ground surfaces 102 and 112, respectively, which serve as reference potentials for the respective transmission lines makes it possible to increase the line widths W1 and W2. This strengthens electromagnetic coupling between the transmission lines and makes it possible to obtain a large communication gain even with the compact coupler and further obtain a sufficient communication gain even if the signal lines are shifted from each other at respective center positions. Furthermore, in a case where the wireless communication coupler is disposed in proximity to the wireless power transmission coupler, it is possible to reduce eddy current generated on the ground surface by the power transmission coupler. As a result, it is possible to reduce the deterioration of transmission efficiency in wireless power transmission.

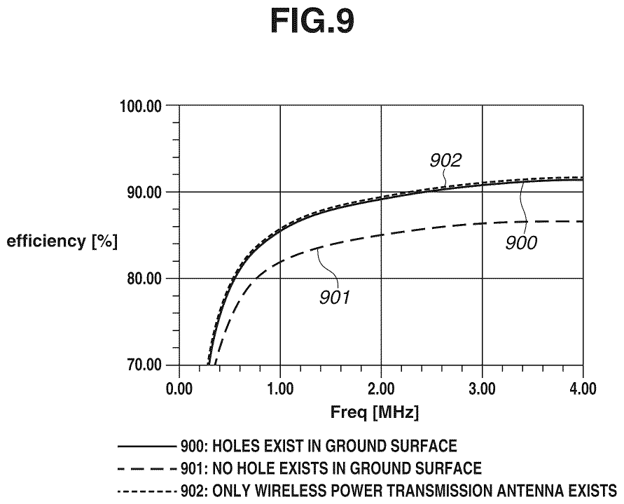

FIG. 9 is a characteristic diagram illustrating simulation results of transmission efficiency in wireless power transmission in a case where the wireless power transmission coupler and the wireless communication coupler are disposed in proximity to each other as illustrated in FIG. 8. The simulation in FIG. 9 has been conducted on the assumption that the reception coupler and the transmission coupler are mounted on a general FR4 circuit board.

Efficiency 900 represents a simulation result obtained in a case where rhombic holes are periodically formed in the ground surfaces of the transmission lines of the transmission and reception couplers of the wireless communication coupler as illustrated in FIG. 8. Efficiency 901 represents a simulation result obtained in a case where the wireless power transmission coupler and the wireless communication coupler using the transmission line in which no hole is formed in the ground surface are disposed in proximity to each other. Efficiency 902 represents a simulation result obtained in a case where only the wireless power transmission coupler exists.

As illustrated in FIG. 9, in the case where no hole is formed in the ground surface, the transmission efficiency deteriorates significantly. In contrast, forming the holes in the ground surface reduces the deterioration of transmission efficiency.

Based on the above-mentioned simulation results, it has been found that, even in a case where the wireless power transmission coupler and the wireless communication coupler are disposed in proximity to each other, using the coupler in which the holes are formed in the ground surface makes it possible to reduce the deterioration of transmission efficiency in wireless power transmission.

Additionally, while the description has been given of the example in the case where the holes are formed in both the ground surface of the reception coupler and the ground surface of the transmission coupler in the present exemplary embodiment, the holes may be formed only in the ground surface of the reception coupler or only in the ground surface of the transmission coupler. Even in this case, the wireless communication apparatus using the compact coupler that can reduce the deterioration of transmission efficiency in wireless power transmission, and the wireless communication system are implemented similarly to the configuration in FIG. 8.

Additionally, while the description has been given of the example in the case where the wireless power transmission coupler and the wireless communication coupler are formed on the identical circuit board in the present exemplary embodiment, they may be formed on individual circuit boards.

According to the present exemplary embodiment, since it is possible to reduce the influence on transmission efficiency in wireless power transmission even if the wireless power transmission coupler and the wireless communication coupler are disposed in proximity to each other so as to be fitted in a mounting space for couplers, the wireless communication system that can perform highly efficient wireless power transmission is implemented.

It has been described in the first and second exemplary embodiments that forming the holes in the ground surface of the coupler makes it possible to reduce the size of the coupler while ensuring a large gain. In a fourth exemplary embodiment, a description will be given of a configuration in which a coupler in which holes are formed in the ground surface functions as a filter. A configuration of the wireless communication system and a function of each component according to the present exemplary embodiment are similar to those in the first exemplary embodiment, and thus descriptions thereof are omitted.

The reception coupler 100 according to the present exemplary embodiment uses the principle that the formation of holes in the ground surface 102, which serves as a reference potential, weakens electromagnetic coupling to the signal line 101 and makes it possible to increase the line width W1 in comparison with the case where no hole is formed in the ground surface. The electromagnetic coupling between the signal line 101 and the ground surface 102 becomes weaker as the holes in the ground surface become larger. When the electromagnetic coupling between the signal line 101 and the ground surface 102 weakens, a transmission characteristic of the transmission line rapidly deteriorates as a frequency increases. With use of this characteristic, it is possible to use each of the reception coupler and the transmission coupler in the present exemplary embodiment as a low-pass filter.

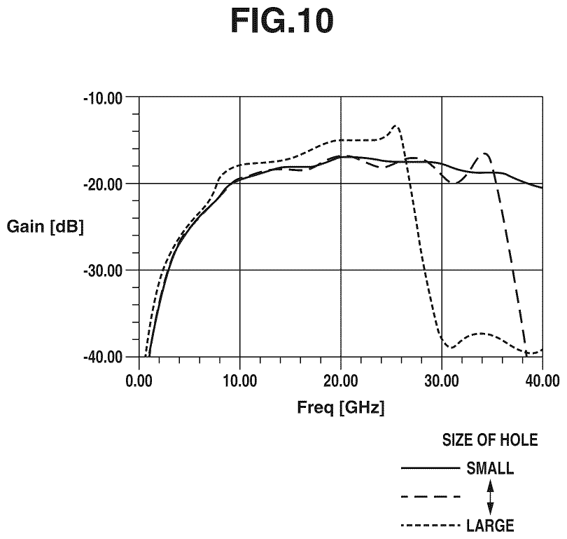

FIG. 10 is a characteristic diagram illustrating simulation results of a gain of the reception coupler in a case where the coupler in which the holes are formed in the ground surface is used as a communication coupler and a size of each hole is changed. In the simulation in FIG. 10, the size of the holes in the ground surface and an amount of the conductor are changed while characteristic impedance of the transmission line is maintained at 50Ω.

FIG. 10 illustrates that a gain obtained at high frequencies becomes smaller as the size of each hole becomes larger. Since the gain changes sharply as illustrated in FIG. 10, the coupler can be used as a low-pass filter that cuts high frequency components. Based on the above-mentioned results, it has been found that using the coupler in which holes are formed in the ground surface as the reception coupler for wireless communication makes it possible to use the coupler as the low-pass filter. Frequencies to be cut can be controlled depending on the size of the holes. As a result, with the configuration using the compact coupler that can perform stable communication, the highly convenient wireless communication system into which the low-pass filter is built is implemented.

Additionally, in the present exemplary embodiment, the description has been given of the configuration in which the holes 102a are formed in the ground surface 102 of the reception coupler 100 and no hole is formed in the ground surface 112 of the transmission coupler 110. Instead of such a configuration, a configuration in which no hole is formed in the ground surface 102 and holes similar to the holes 102a are formed in the ground surface 112, or a configuration in which holes similar to the holes 102a are formed both in the ground surface 102 and the ground surface 112 may be employed. Even in this case, with the configuration using the compact coupler that can perform stable communication, the highly convenient wireless communication system into which the low-pass filter is built is implemented.

The disclosure of the exemplary embodiments of the present invention includes the following configurations.

### (Configuration 1)

A wireless communication apparatus configured to perform wireless communication with another wireless communication apparatus, the wireless communication apparatus including a coupler configured to be electromagnetically coupled to the another wireless communication apparatus, in which the coupler includes a signal line, and a ground surface including a conductor, and the ground surface does not include the conductor in part of a region overlapping with the signal line in a plan view.

### (Configuration 2)

The wireless communication apparatus according to Configuration 1, in which, on the ground surface, a missing portion in which the conductor is missing is formed, and a portion without the conductor is created by the missing portion.

### (Configuration 3)

The wireless communication apparatus according to Configuration 2, in which, on the ground surface, a plurality of polygonal holes is periodically formed as the missing portion.

### (Configuration 4)

The wireless communication apparatus according to Configuration 3, in which, on the ground surface, the plurality of holes is formed along a longitudinal direction of the signal line.

### (Configuration 5)

The wireless communication apparatus according to Configuration 3 or 4, in which, on the ground surface, the plurality of holes is formed to intersect with the longitudinal direction of the signal line.

### (Configuration 6)

The wireless communication apparatus according to any one of Configurations 1 to 5, in which the ground surface includes a region in which the conductor is formed entirely.

### (Configuration 7)

The wireless communication apparatus according to any one of Configurations 1 to 6, in which the conductor intersects with the signal line in the region overlapping with the signal line in the plan view.

### (Configuration 8)

The wireless communication apparatus according to any one of Configurations 1 to 7, in which, on the ground surface, the conductor that exits in the region overlapping with the signal line in the plan view is divided.

### (Configuration 9)

The wireless communication apparatus according to any one of Configurations 1 to 8, in which a maximum size of the portion without the conductor is determined by an upper limit of frequencies at which a signal is transmitted to the signal line.

### (Configuration 10)

The wireless communication apparatus according to Configuration 1, in which the coupler is configured to function as a low-pass filter.

### (Configuration 11)

The wireless communication apparatus according to any one of Configurations 1 to 10, in which the coupler is a microstrip line or a coplanar line including a ground guard.

### (Configuration 12)

The wireless communication apparatus according to any one of Configurations 1 to 11, in which the wireless communication apparatus is a reception apparatus configured to perform wireless reception.

### (Configuration 13)

The wireless communication apparatus according to any one of Configurations 1 to 11, in which the wireless communication apparatus is a transmission apparatus configured to perform wireless transmission.

### (Configuration 14)

A wireless communication system including a first wireless communication apparatus including a first coupler and a second wireless communication apparatus including a second coupler configured to be electromagnetically coupled to the first coupler, the second wireless communication apparatus being configured to perform wireless communication with the first wireless communication apparatus, in which the first coupler includes a first signal line and a first ground surface including a first conductor, the second coupler includes a second signal line and a second ground surface including a second conductor, and one or both of the following (1) and (2) are satisfied:
(1) the first ground surface does not include the first conductor in part of a region overlapping with the first signal line in a plan view, and
(2) the second ground surface does not include the second conductor in part of a region overlapping with the second signal line in the plan view.

According to the various exemplary embodiments, the wireless communication apparatus using the compact coupler that can perform stable communication, and the wireless communication system are implemented.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-154915, filed Sep. 9, 2024, which is hereby incorporated by reference herein in its entirety.

What is claimed is:

1. A wireless communication apparatus configured to perform wireless communication with another wireless communication apparatus, the wireless communication apparatus comprising:
a coupler configured to be electromagnetically coupled to the another wireless communication apparatus,
wherein the coupler includes:
a signal line; and
a ground surface including a conductor, and
wherein the ground surface does not include the conductor in a part of a region overlapping with the signal line in a plan view.

2. The wireless communication apparatus according to claim 1, wherein, on the ground surface, a missing portion in which the conductor is missing is formed, and a portion without the conductor is created by the missing portion.

3. The wireless communication apparatus according to claim 2, wherein, on the ground surface, a plurality of polygonal holes is periodically formed as the missing portion.

4. The wireless communication apparatus according to claim 3, wherein, on the ground surface, the plurality of polygonal holes is formed along a longitudinal direction of the signal line.

5. The wireless communication apparatus according to claim 3, wherein, on the ground surface, the plurality of polygonal holes is formed to intersect with a longitudinal direction of the signal line.

6. The wireless communication apparatus according to claim 1, wherein the ground surface includes a region in which the conductor is formed entirely.

7. The wireless communication apparatus according to claim 1, wherein the conductor intersects with the signal line in the region overlapping with the signal line in the plan view.

8. The wireless communication apparatus according to claim 1, wherein, on the ground surface, the conductor that exits in the region overlapping with the signal line in the plan view is divided.

9. The wireless communication apparatus according to claim 1, wherein a maximum size of a portion without the conductor is determined by an upper limit of frequencies at which a signal is transmitted to the signal line.

10. The wireless communication apparatus according to claim 1, wherein the coupler is configured to function as a low-pass filter.

11. The wireless communication apparatus according to claim 1, wherein the coupler is a microstrip line or a coplanar line including a ground guard.

12. The wireless communication apparatus according to claim 1, wherein the wireless communication apparatus is a reception apparatus configured to perform wireless reception.

13. The wireless communication apparatus according to claim 1, wherein the wireless communication apparatus is a transmission apparatus configured to perform wireless transmission.

14. A wireless communication system comprising:
a first wireless communication apparatus including a first coupler; and
a second wireless communication apparatus including a second coupler configured to be electromagnetically coupled to the first coupler, the second wireless communication apparatus being configured to perform wireless communication with the first wireless communication apparatus,
wherein the first coupler includes:
a first signal line; and
a first ground surface including a first conductor,
wherein the second coupler includes:
a second signal line; and
a second ground surface including a second conductor, and
wherein one or both of the following (1) and (2) are satisfied:
(1) the first ground surface does not include the first conductor in a part of a region overlapping with the first signal line in a plan view, and
(2) the second ground surface does not include the second conductor in a part of a region overlapping with the second signal line in the plan view.
